(19) United States
(12) Patent Application Publication
(10) Pub. No.: US 2024/0386341 A1
(43) Pub. Date: Nov. 21, 2024

(54) CURRICULUM GENERATION FOR CUSTOMIZED LEARNING SOLUTIONS

(71) Applicant: International Business Machines Corporation, Armonk, NY (US)

(72) Inventors: Philip Siconolfi, Croton on Hudson, NY (US); Ann M. DePaolo, Legrangeville, NY (US); Danielle Atwood, North Babylon, NY (US); David F. Hans, Castleton, NY (US); Geoffrey Smith, Saugerties, NY (US)

(21) Appl. No.: 18/319,520

(22) Filed: May 18, 2023

(51) Int. Cl. G06Q 10/0631; G06Q 10/0639; G06Q 50/20

(52) U.S. Cl. CPC G06Q 10/063112; G06Q 10/06395; G06Q 50/2057

(57) ABSTRACT

Disclosed embodiments provide techniques for curriculum generation for customized learning solutions. A job description is obtained, and a user's current skill level is assessed. Discrepancies are identified and a customized learning solution is generated based on the deficiencies. Factors such as cost, completion time, learning preferences, and course ratings are included in the generation of the customized learning solution. In this way, users obtain a customized learning solution that provides a path for the users to acquire the needed skills for a desired job, thereby increasing the opportunities for workers, and enabling companies, government, and other institutions to increase the productivity of their workforce.

### FIELD

The present invention relates generally to computerized curriculum generation, and more particularly, to curriculum generation for customized learning solutions.

### BACKGROUND

Effective training is important for career advancement in today's workforce. Training can help employees improve their skills and knowledge, which can make them more valuable to their organization. With the right training, employees can develop new abilities, enhance existing ones, and become more proficient in their work. Additionally, effective training can lead to increased productivity. As workers gain new skills, they can complete tasks more quickly and accurately, resulting in greater output and improved quality.

In addition to benefits that effective worker training provides to enterprises, it also provides significant benefits to the workers, regardless of if they are full-time employees, contractors, freelancers, and/or other types of workers. Training provides workers with the opportunity to develop and enhance their careers. When workers acquire new skills, they may be able to take on new roles or responsibilities within their organization, or even move up the career ladder. Additionally, training can help improve overall job satisfaction. When workers receive effective training, they feel more confident and capable in their roles, which can lead to greater job satisfaction. This can also result in improved morale and reduced turnover, which also provides benefits to the enterprises as well. Overall, effective training is critical for career advancement as it helps employees gain new skills, increase productivity, enhance their career prospects, boost job satisfaction, and provide their organization with a competitive advantage.

### SUMMARY

In one embodiment, there is provided a computer-implemented method for curriculum generation, comprising: obtaining a first job description; obtaining a possessed knowledge set for a user; determining a deficiency list based on the first job description and the possessed knowledge set; and generating a customized learning solution based on the deficiency list, wherein the customized learning solution comprises at least one subset of material from a curriculum material corpus.

In another embodiment, there is provided an electronic computation device comprising: a processor; a memory coupled to the processor, the memory containing instructions, that when executed by the processor, cause the electronic computation device to: obtain a first job description; obtain a possessed knowledge set for a user; determine a deficiency list based on the first job description and the possessed knowledge set; and generate a customized learning solution based on the deficiency list, wherein the customized learning solution comprises at least one subset of material from a curriculum material corpus.

In another embodiment, there is provided a computer program product for an electronic computation device comprising a computer readable storage medium having program instructions embodied therewith, the program instructions executable by a processor to cause the electronic computation device to: obtain a first job description; obtain a possessed knowledge set for a user; determine a deficiency list based on the first job description and the possessed knowledge set; and generate a customized learning solution based on the deficiency list, wherein the customized learning solution comprises at least one subset of material from a curriculum material corpus.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart indicating process steps for embodiments of the present invention.

FIG. 4 is an exemplary first job description in accordance with disclosed embodiments.

FIG. 5 is an exemplary user profile in accordance with disclosed embodiments.

FIG. 6 is an exemplary self-assessment in accordance with disclosed embodiments.

FIG. 7 shows exemplary self-assessment results in accordance with disclosed embodiments.

FIG. 8 is an exemplary alternate job list in accordance with disclosed embodiments.

FIG. 9 shows exemplary alternate job list details in accordance with disclosed embodiments.

FIG. 10 is an exemplary customized indexing list in accordance with disclosed embodiments.

FIG. 11 shows an exemplary training user interface in accordance with disclosed embodiments.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Skills training can be an important part of career advancement. While many opportunities for learning exist today, in some ways, the number of choices can be overwhelming for a user. First, a user has to wade through many unnecessary courses to find courses on the topics he/she needs. Of those courses, some may be free while others have associated costs. Some courses may not be offered consistently, or may not start until some point deep into the future. Facing these challenges, many would-be learners may get discouraged and simply give up, and not apply for a job because they lack the needed skills, and acquiring those skills seems like a daunting task.

Disclosed embodiments provide techniques for curriculum generation for customized learning solutions. A job description is obtained, and a user's current skill level is assessed. Discrepancies are identified and a customized learning solution is generated based on the deficiencies. Factors such as cost, completion time, learning preferences, and course ratings are included in the generation of the customized learning solution. In this way, users obtain a customized learning solution that provides a path for the users to acquire the needed skills for a desired job, thereby increasing the opportunities for workers, and enabling companies, government, and other institutions to increase the productivity of their workforce. As the number of users of disclosed embodiments increases, the systems can provide continually enhanced education plans with more resources and greater accuracy.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

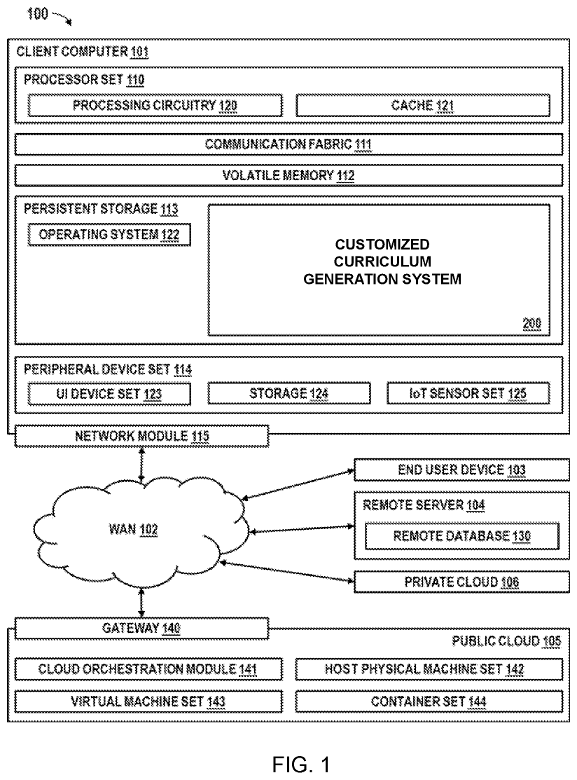

FIG. 1 shows an exemplary computing environment 100 in accordance with disclosed embodiments. Computing environment 100 contains an example of an environment for the execution of at least some of the computer code involved in performing the inventive methods, such as customized curriculum generation system shown at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

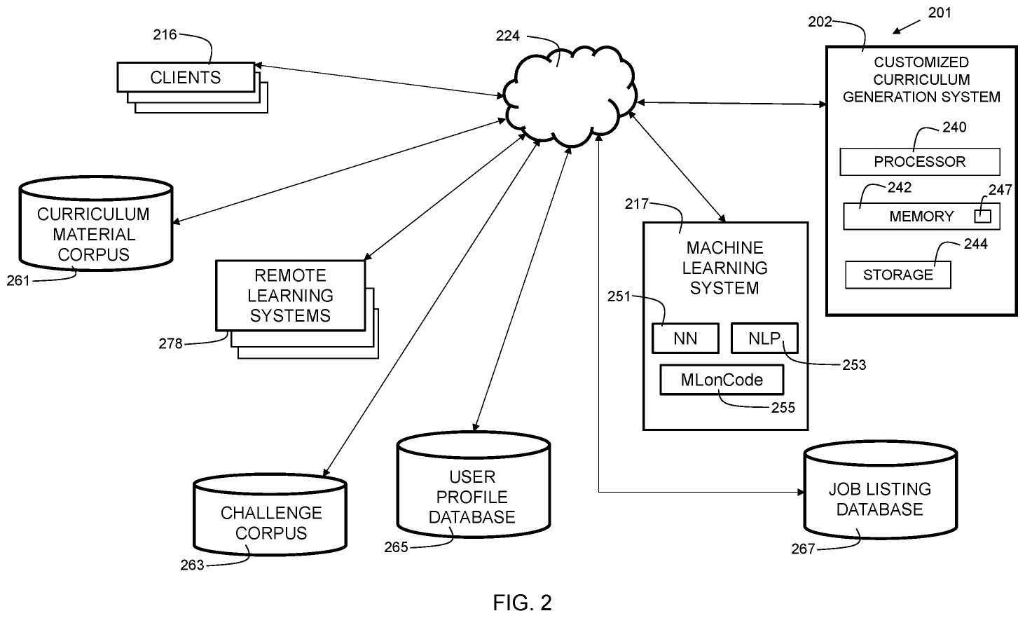

FIG. 2 is an exemplary ecosystem 201 in accordance with disclosed embodiments. Customized Curriculum Generation System (CCGS) 202 comprises a processor 240, a memory 242 coupled to the processor 240, and storage 244. CCGS 202 is an electronic computation device. The memory 242 contains program instructions 247, that when executed by the processor 240, perform processes, techniques, and implementations of disclosed embodiments. Memory 242 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The CCGS 202 is configured to interact with other elements of ecosystem 201. CCGS 202 is connected to network 224, which is the Internet, a wide area network, a local area network, or other suitable network.

Ecosystem 201 may include one or more remote learning systems 278. The remote learning system 278 can include servers and backend applications for hosting and providing online video lessons and an online portal for taking self-assessments, and/or other activities for promotion of learning and assessment of educational material.

Ecosystem 201 may include one or more client devices, indicated as 216. Client device 216 can include a laptop computer, desktop computer, tablet computer, or other suitable computing device. Client device 216 may be used to interact with remote learning system 278 to enable end-users to provide training via online courses, including, but not limited to, online programming courses. The programming courses can present education material and provide assessments for languages such as C, C++, Python, bash, Java, JavaScript, and/or other programming languages. Additionally, other technical and/or business topics can be taught by remote learning systems 278 instead of, or in addition to, programming languages. Additionally, client device 216 may be used to configure features in the CCGS 202, including features such as generating a customized learning solution based on a job description, a possessed knowledge set, and/or a deficiency list.

Ecosystem 201 may include machine learning system 217. The machine learning system 217 can include a neural network (NN) 251, and/or a natural language processing (NLP) module 253. In some embodiments, the machine learning system 217 may include a Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques.

The NLP module 253 may include software and/or hardware for performing Natural Language Processing (NLP). NLP is a subfield of artificial intelligence that involves teaching computers to understand, interpret, and generate human language. NLP works by breaking down human language into its constituent parts and analyzing them using various algorithms and techniques. In one or more embodiments, the NLP process includes tokenization, which can include breaking down a piece of text into individual words or phrases. The NLP process can further include Part-of-speech (POS) tagging. POS tagging can include analyzing each token and assigning it a part of speech, such as noun, verb, adjective, or adverb. The NLP process can further include parsing, which involves analyzing the syntactic structure of a sentence to identify the relationships between the words and phrases. The process can include entity detection, which involves identifying and categorizing named entities in a piece of text, such as people, places, organizations, and dates. One or more embodiments can include performing sentiment analysis. The sentiment analysis can include analyzing the overall sentiment or emotional tone of a piece of text, such as whether it is positive, negative, or neutral. Finally, the results of the NLP process may be further refined using post-processing techniques such as entity co-reference resolution and/or disambiguation. In disclosed embodiments, the entity detection extracts keywords and meanings from job descriptions, in order to determine job requirements, in accordance with embodiments of the present invention.

In one or more embodiments, the machine learning system 217 further includes an MLonCode (Machine Learning on Code) module 255. MLonCode (Machine Learning on Code) refers to the use of machine learning techniques to analyze and understand code. MLonCode aims to improve software development processes by automating various tasks such as code review, bug detection, code completion, and refactoring. MLonCode algorithms can be used to classify code according to its type, purpose, or functionality. This can be useful for organizing and searching code repositories, and for identifying patterns or trends in code usage. MLonCode algorithms can be used to detect bugs or errors in code by analyzing its syntax and structure. This can help developers to identify and fix bugs more quickly and efficiently. In embodiments, MLonCode algorithms can be trained to evaluate code submitted as part of self-assessments to ascertain a user's proficiency in a given programming language. In embodiments, MLonCode can be used to analyze the effectiveness of source code, including evaluation of self-assessments for determining a customized learning solution for a user. Disclosed embodiments may utilize xAPI, and/or other suitable techniques for tracking and administering self-assessments.

xAPI (Experience API), is a standard for tracking and communicating learning experiences and related data. xAPI is designed to capture a wide variety of learning experiences beyond traditional e-learning courses, including simulations, virtual reality experiences, games, mobile learning, and informal learning. It allows the tracking of learning experiences that occur both online and offline, and across multiple platforms and devices. xAPI is based on a simple statement structure that consists of a subject, verb, and object. These statements can be sent from any source, such as a learning management system (LMS), a mobile app, or a web browser, to a repository (e.g., Learning Record Store) that securely stores and manages the assessment data.

Ecosystem 201 includes a curriculum material corpus 261. The curriculum material corpus 261 can include digital assets such as text, audio, images, video, and/or interactive content. The curriculum material corpus 261 may utilize a database, such as a SQL database, to store and/or index the content within the curriculum material corpus 261. The content within the curriculum material corpus 261 may be organized into chapters, lessons, subchapters, etc. In embodiments, the curriculum material corpus includes text, audio, and/or at least one image. In one or more embodiments, educational video assets are analyzed and modified to create a customized learning solution. As an example, an educational video asset can contain a first chapter on wired ethernet, a second chapter on WiFi, and a third chapter on router configuration. If the customized learning solution warrants a user to learn wired ethernet and router configuration, but does not require WiFi training, then disclosed embodiments can compile a subset of the plurality of sections into a new educational video asset that includes the first chapter and the third chapter, but without the second chapter. Thus, the new educational video asset includes only what is needed for the specific training situation, thereby saving time for users that need to learn new skills quickly and efficiently in order to pursue new career opportunities.

Ecosystem 201 includes a challenge corpus 263. The challenge corpus 263 includes a collection of tests, quizzes, homework problems, and the like. The challenge corpus 263 may utilize a database, such as a SQL database, to store and/or index the content within the challenge corpus 263. The content within the challenge corpus 263 may be organized into chapters, lessons, subchapters, etc., on various topics. The topics can include programming languages, software applications, technology topics, science, math, business, and so on. In one or more embodiments, a possessed knowledge set for a user is obtained by providing self-assessments to a user that are selected from the challenge corpus 263. The selections from the challenge corpus 263 can be based on job requirements. Using the machine learning system 217 and NLP module 253, a job description is analyzed to obtain the job requirements. Entity detection and/or other techniques are used to identify skills and experience that is desired or needed for a job. These requirements are compared against the possessed knowledge set.

Ecosystem 201 includes a user profile database 265. The user profile database 265 can include information pertaining to a user. The information can include education level, self-reported skills, assessed skills, certifications, and so on. The user profile database can also include learning preferences for the user. The learning preferences can include a variety of attributes, such as a time range preference. As an example, some users may prefer training courses that take no longer than two weeks to complete, while other users may prefer longer courses such as semester or full year courses. The learning preferences can include a cost range. As an example, some users may prefer training courses that are free or under a predetermined cost, while for other users, more expensive courses are acceptable. The learning preferences can include an instruction type preference. As an example, some users prefer remote learning, while other users may prefer in-person learning. With remote learning, some users may prefer completely asynchronous learning, while other users may prefer instructor-led remote learning. In one or more embodiments, the learning preferences are used to create a customized learning solution that meets the needs of a user and teaches topics that are requirements for a job position that a user is seeking. One or more embodiments can filter out courses that do not meet the criteria (e.g., time range, cost range, instruction type preference) specified by a user, and exclude them from a customized learning solution.

Ecosystem 201 includes a job listing database 267. The job listing database may include a SQL database, and/or other suitable database type. The job listing database can include one or more sentences that comprise a job description. The job listing may be further tagged with metadata including job type, technology area, experience range, geographic location, remote status, required certifications, salary range, and/or other metadata fields. In disclosed embodiments, when a user selects a job from the job listing database 267, the CCGS 202 can utilize the machine learning system 217 to extract job requirements, compare those requirements to the skills for the user from the user profile database, and derive a customized learning plan for the user for training the user on deficiencies (job requirements that a user currently does not possess). The training on deficiencies can be based on material stored in the curriculum material corpus 261. As new curriculum, such as a new educational video asset, is generated, the new curriculum can be stored in the curriculum material corpus, enabling reuse for future users that have similar learning needs.

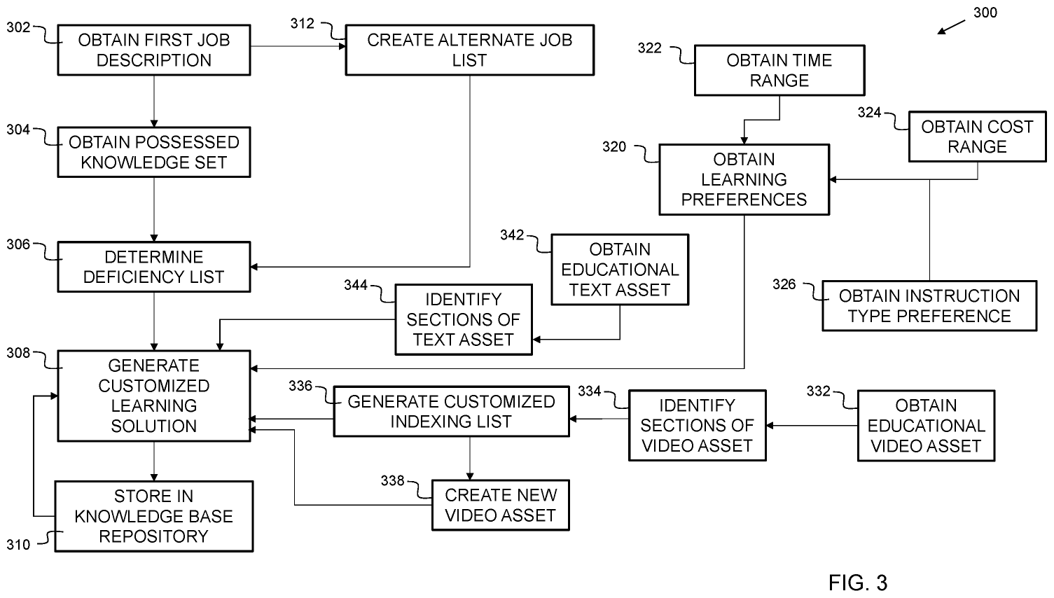

FIG. 3 is a flowchart 300 indicating process steps for embodiments of the present invention. At block 302, a first job description is obtained. A first job description refers to a job description for a job that the user selected. In one or more embodiments, the flowchart can include, at block 312, creating an alternate job list. These are jobs that may have a description similar to the first job description, but may have different job requirements. Disclosed embodiments can identify, using NLP, job descriptions from similar jobs. In some situations, the alternate jobs may have fewer requirements that the user is deficient in, and thus, a shorter training period. Disclosed embodiments can provide a user with options for determining which job posting(s) to pursue, along with an estimate of a training duration for that job. In some embodiments, jobs can be ranked by various criteria, including, training time and/or training cost in order to prepare to apply for the job, market value for the job, and/or other criteria. This allows users to make informed decisions about which jobs they should apply for.

The flowchart continues at block 304 with obtaining a possessed knowledge set. The possessed knowledge set is the set of skills, training, credentials, etc. that a user possesses. The possessed knowledge set can be based on information reported by the user, knowledge assessments completed by the user, and so on. The flowchart continues at block 306, where a deficiency list is determined. The deficiency list represents topics/subjects that are job requirements for which the user does not currently have adequate proficiency. In general, the deficiency list D can be defined as:

D=J−P

Where J represents the set of job requirements, and P represents the set of topics that the user has proficiency in. D represents a set of items in set J that are not in set P. The set D, therefore represents topics on which the user needs additional training in order to satisfy the job requirements. As an example, a job description for a software engineer may list requirements of proficiency in the programming languages of Java, Python, and C++, and familiarity with data compression. A hypothetical user may have a possessed knowledge set of C++ and data compression. In this example, the deficiency list includes Java and Python. That is, Java and Python are job requirements that the user currently does not have proficiency in. A customized learning solution for this example includes training in Java and Python. Since the user already has proficiency in C++ and data compression, the customized learning solution may omit these topics. Embodiments can include creating an alternate job list, and the alternate job list can be based on the first job description and the possessed knowledge set.

The flowchart continues with generating a customized learning solution at block 308. The customized learning solution is based on what the user needs to learn, as well as how the user wishes to learn it. Topics described in a deficiency list represent what the user needs to learn. In one or more embodiments, the customized learning solution comprises at least one subset of material from a larger corpus of curriculum material. In one or more embodiments, the curriculum material corpus is processed by natural language processing by machine learning system 217 to extract the one or more subsets, based on the deficiency list and the possessed knowledge set. The flowchart includes obtaining learning preferences 320. The learning preferences describe how the user wishes to learn. The learning preferences can include obtaining a time range 322. The time range can represent a time range in hours, days, weeks, months, semesters, years, or other suitable time unit. In a situation such as a job opening that is being filled immediately, a user may elect a shorter time range, such as one week. For longer term career planning, a user may elect a longer time range, such as six months. Embodiments can filter curriculum based on the time range. Thus, if the user selects two weeks as a time range, then courses that take longer than two weeks to complete may be excluded from the customized learning solution. The learning preferences can include obtaining a cost range 324. The cost range can represent a cost range in fiat currency, such as US dollars, Canadian dollars, Euros, etc. The cost range can represent a cost range in cryptocurrency, and/or other tokens that are redeemable for education/training. Embodiments can filter curriculum based on the cost range. Thus, if the user selects $500 USD as a cost range, then courses that cost more than $500 USD may be excluded from the customized learning solution.

The learning preferences can include obtaining an instruction preference type 326. Depending on the topic, and the person, some users may prefer in-person learning. Others, based on their schedule, and/or other factors, may prefer remote learning. Within remote learning, there are numerous subvarieties, such as self-paced, asynchronous paced, and live instructor-led. Embodiments can include obtaining a time range, and generating the customized learning solution can be based on the time range. Embodiments can include obtaining a cost range, and generating the customized learning solution can be based on the cost range. Embodiments can include obtaining an instruction type preference, and generating the customized learning solution can be based on the instruction type preference.

Generating the customized learning solution can include obtaining at least one educational video asset at block 332. In embodiments, multiple educational video assets may be obtained, to cover topics in a deficiency list determined at block 306. In one or more embodiments, the videos are obtained from the curriculum material corpus 261. Embodiments can include obtaining at least one educational video asset; identifying a plurality of sections within the at least one educational video asset; and compiling a subset of the plurality of sections into a new educational video asset, based on the deficiency list. Embodiments can further include storing the new educational video asset in a knowledge base repository.

At block 334, sections of the video asset are identified. The sections may be identified based on metadata included with the video asset, and/or derived via dividing the video into a series of discrete frames or sequences. The frames/sequences are provided to the machine learning system 217 that is trained to identify key elements in a video, such as titles, captions, or other visual indicators of a chapter boundary. This information is then used to determine the approximate locations of each chapter within the video. To further refine the chapter boundaries, the machine learning system 217 analyzes the audio track of the video and uses speech recognition to identify spoken cues, such as words or phrases that are commonly used to indicate a new chapter. In one or more embodiments, the machine learning system 217 then generates a customized indexing list at block 336 that includes a listing of the chapters/sections/topics, along with corresponding start and end times, which is used by disclosed embodiments to only include necessary sections/portions of videos in customized learning solutions by creating a new video asset at block 338. The new video asset is then provided as part of a customized learning solution at block 308. In some embodiments, the customized indexing list may be used as part of a customized learning solution, without the need to render a new video. In those embodiments, a special-purpose media player or browser plugin may enable randomized access of the original video asset, based on the customized indexing list. This can increase performance and reduce usage of important computer resources such as processor utilization, memory utilization, and network bandwidth, since new videos are not rendered, but rather, the user is directed to various sections of one or more video assets based on information in the customized indexing list.

The customized learning solution generated at block 308 is then stored in a knowledge base repository at block 310. This enables the customized learning solutions, which can include videos, text, audio, images, and/or other media content, to be reused in the event a user needs to repeat the training at a later date, and/or other users need similar training.

Optionally, at block 342, educational text assets are obtained. The educational text assets can include web pages, online textbooks, dictionaries, knowledge bases, and so on. At block 344, one or more sections of the text asset are identified. This can include processing the text and transforming it into a machine-readable format, such as plain text or HTML. Disclosed embodiments then utilize NLP, as stated previously, including part-of-speech tagging and/or dependency parsing, to analyze the structure of the text and identify the main ideas and themes being discussed. Based on this analysis, disclosed embodiments group the paragraphs or sentences within the article into coherent sections or themes. Disclosed embodiments, then use techniques such as named entity recognition to identify key terms and/or phrases within each section, which are then used as headings and/or labels for the sections. Disclosed embodiments then generate a table of contents and/or outline for the article, with each section labeled and linked to the corresponding content within the article or text file, which is then used by disclosed embodiments to only include relevant pieces of articles or text in customized learning solutions, based on items in the deficiency list that was determined at block 306. While flowchart 300 depicts a particular sequence, in embodiments, one or more of the steps may be performed in a different order, performed concurrently, or omitted.

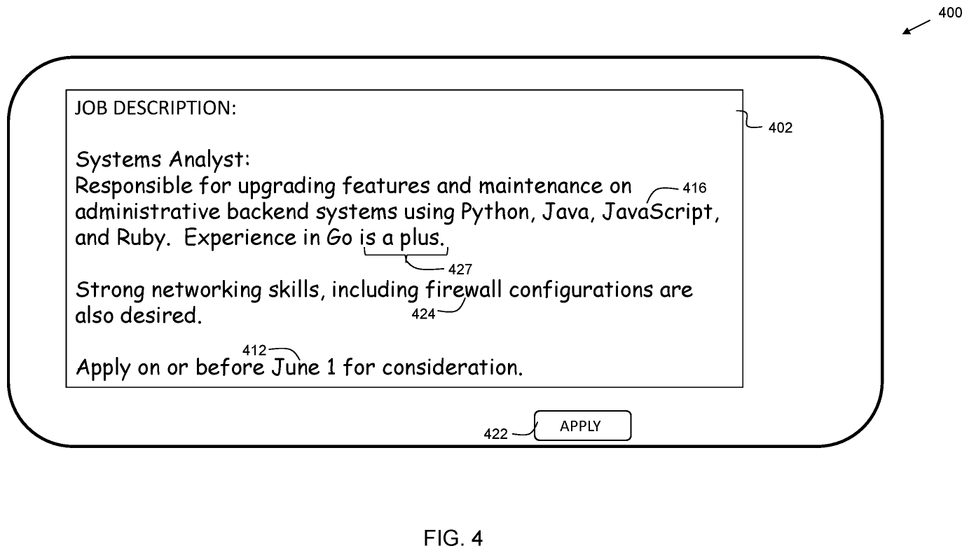

FIG. 4 is an exemplary first job description example 400 in accordance with disclosed embodiments. The user interface shown in FIG. 4 may be rendered on a client device such as 216 of FIG. 2. Example 400 includes job description text at 402. The job description text includes one or more keywords, such as indicated at 416 and 424. For the sake of clarity, not all keywords are indicated with a reference number. In one or more embodiments, words denoting programming languages, such as Python, Java, JavaScript, Ruby, and Go, are indicated as keywords. Additionally, other words denoting subjects/topics, such as ‘firewall’ at 424 may also be included as keywords to determine requirements. Dates, such as indicated at 412 may be used in one or more embodiments to set a default time range, based on the deadline for applying to the job. In the example 400, disclosed embodiments can create a customized learning solution that can be completed before June 1, based on the date indicated at 412. In one or more embodiments, a phrase such as ‘is a plus’ as denoted at 427, can be used to assess if a subject/topic is optional, or required. In the example 400, the language Go is deemed to be optional. Disclosed embodiments may include optional topics in a customized learning solution, and provide an option for a user to select or skip those topics, based on the user's time constraints and/or other preferences. In embodiments, when the user invokes (clicks, taps, or otherwise selects) the Apply button 422, the CCGS 202 may perform additional steps prior to enabling the completing of an application for the job. The additional steps can include, performing an assessment to determine a possessed knowledge set, if not already performed. The additional steps can also include creating an alternate job list, which includes similar jobs, but possibly having different requirements. Disclosed embodiments utilize kNN (nearest neighbors), K-means, random forest, clustering, and/or other suitable techniques for identifying other jobs with similar roles to the job that the user selected (the first job description).

The k-Nearest Neighbors (kNN) algorithm works by finding the k nearest neighbors in the training data to a new data point and using the majority class (for classification) or the mean value (for regression) of their outputs as the prediction for the new point. In embodiments, the distance between data points can be measured using Euclidean distance, but other distance metrics can be used in some embodiments.

K-means is an unsupervised machine learning algorithm for clustering data into groups based on their similarities. It is used to identify patterns in data and is often used for segmentation or categorization tasks. The algorithm works by partitioning a set of data points into k clusters, where k is a predetermined number chosen by the user. The algorithm then iteratively assigns each data point to the cluster with the nearest mean (center), and recalculates the mean of each cluster based on the data points assigned to it. This process continues until the clusters converge to a stable solution.

Random forest is a supervised machine learning algorithm used for classification, regression, and other prediction tasks. It is an ensemble learning method that builds multiple decision trees and combines their predictions to produce a more accurate and robust model. The random forest algorithm works by constructing a large number of decision trees, each based on a random subset of the training data and a random subset of the features. During the construction of each tree, the algorithm splits the data into subsets based on the values of the selected features and chooses the best split to maximize the information gain. When making a prediction, the random forest algorithm combines the predictions of all the individual trees by either taking the mode (for classification) or the mean (for regression) of their outputs. This combination of multiple decision trees helps to reduce the risk of overfitting and makes the model more resilient to noise and outliers.

Using the aforementioned techniques, disclosed embodiments can then determine what type of customized learning solution is appropriate for each position, as well as estimating a completion time for each customized learning solution. This information can be presented to the user to enable the user to make an informed decision about which jobs to apply for, and which training to take.

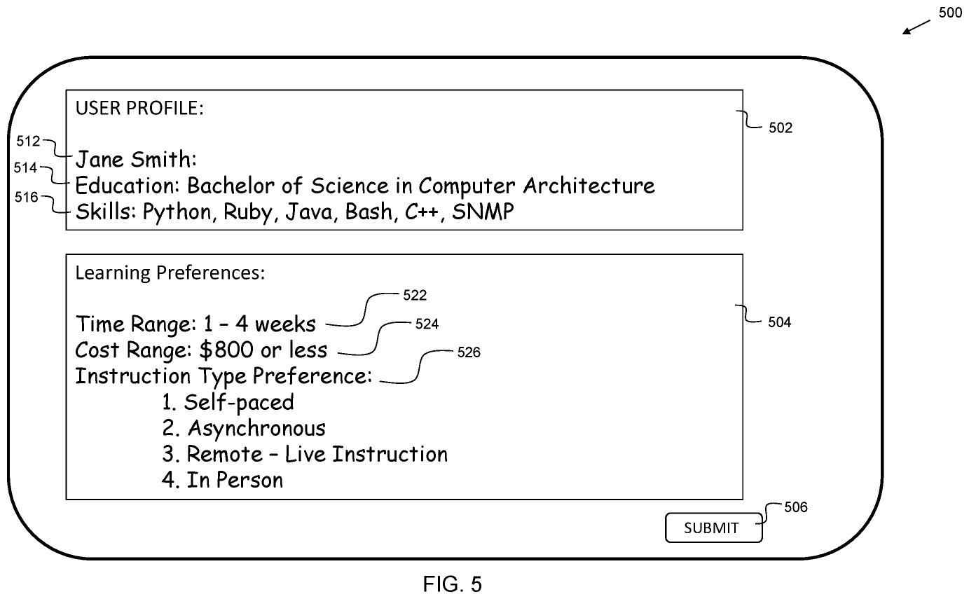

FIG. 5 is an exemplary user interface 500 for entering a user profile in accordance with disclosed embodiments. At section 502, a user profile is entered which includes a user name 512, an education 514, and a list of skills 516. Learning preferences section 504 includes a time range field 522, a cost range field 524, and an instruction type preference 526. In one or more embodiments, the instruction type preference can be entered as a prioritized list. In the example of FIG. 5, the first choice for the user is self-paced, the second choice is asynchronous, the third choice is remote with live instruction, and the fourth choice is in-person. In embodiments, the prioritized list is used to select curriculum that most closely matches what the user needs to learn and how he/she prefers to learn it. The user can invoke (click, tap, or otherwise select) the Submit button 506 to send the information from a client device such as 216, to the CCGS 202 for further processing.

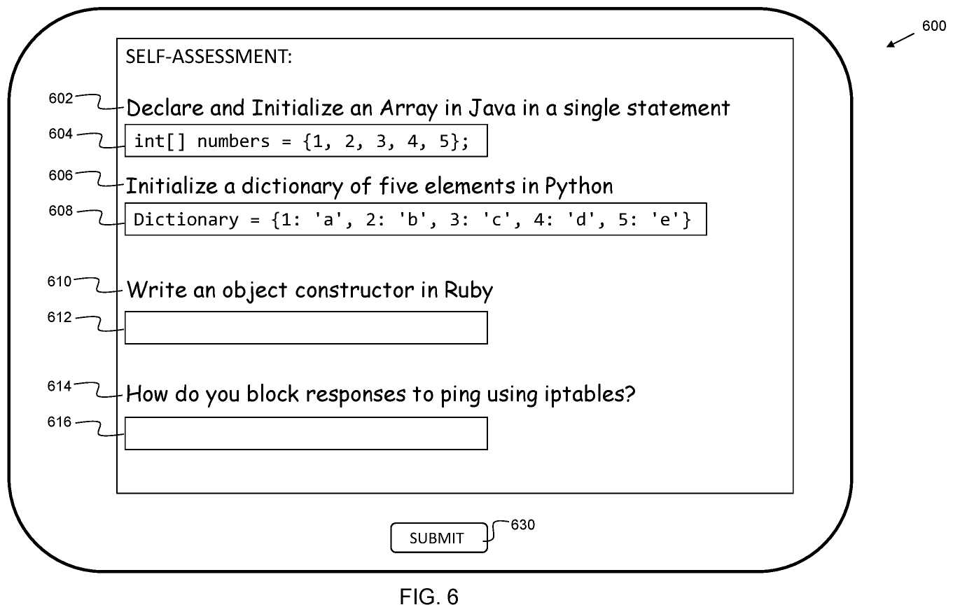

FIG. 6 is an exemplary user interface 600 for a self-assessment in accordance with disclosed embodiments. The self-assessment user interface can include one or more questions (challenges), indicated as 602, 606, 610, and 616. While four questions are shown in user interface 600, in practice, there can be more or fewer questions on the self-assessment. In embodiments, the questions are selected from the challenge corpus 263, based on topics included in the deficiency list and/or job description. In the example, the job description 402 includes requirements such as multiple programming languages, as well as networking skills, particularly in firewall configuration. Thus, the self-assessment questions include questions regarding programming languages (questions at 602, 606, and 610), as well as a question covering networking/firewall knowledge (question at 616). Answer fields are included for a user to provide answers to each question/challenge. Answer field 604 is for providing an answer to the question at 602. Answer field 608 is for providing an answer to the question at 606. Answer field 612 is for providing an answer to the question at 610. Answer field 616 is for providing an answer to the question at 614. Answer field 604 and answer field 608 contain user-provided answers, whereas answer field 612 and answer field 616 are blank, as the user has not yet provided those answers. Once the user has answered as many questions as they can, the user can invoke (click, tap, or otherwise select) the Submit button 630 to provide the completed self-assessment to the CCGS 202. The CCGS 202 may then utilize the machine learning system 217 to grade the submitted self-assessment. In embodiments, the machine learning system 217 may utilize NLP module 253 and/or MLonCode module 255 to grade (evaluate) the self-assessment. Based on results of the evaluation, disclosed embodiments may recommend alternative job postings and/or customized learning solutions.

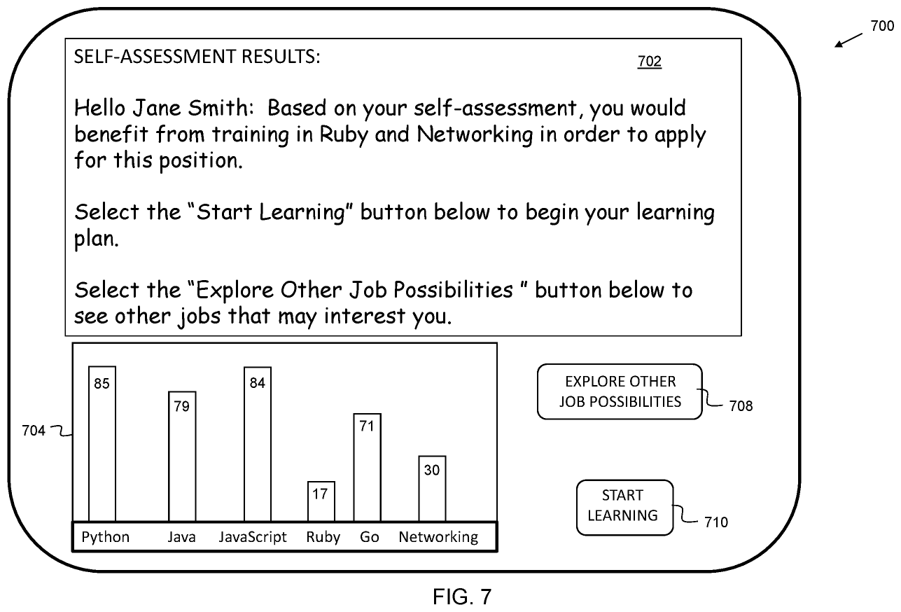

FIG. 7 shows an example of exemplary self-assessment results in accordance with disclosed embodiments. User interface 700 includes a self-assessment summary that is shown at 702. The self-assessment summary may be generated by the machine learning system 217. Optionally, the user interface 700 of FIG. 7 may include a results section 704. The results section can include a textual and/or graphical representation of the assessment results. The user interface 700 of FIG. 7 can further include a button 708 for exploring other job possibilities. The other job possibilities can be retrieved from the job listing database 267. The other job possibilities can be similar to the first job description, and be rendered in an alternate lob list. The user interface 700 of FIG. 7 can further include a button 710 for starting the customized learning solution. Embodiments can include generating a self-assessment test, based on the first job description; and obtaining the possessed knowledge set can include computing a score for the self-assessment test based on received input for the self-assessment test.

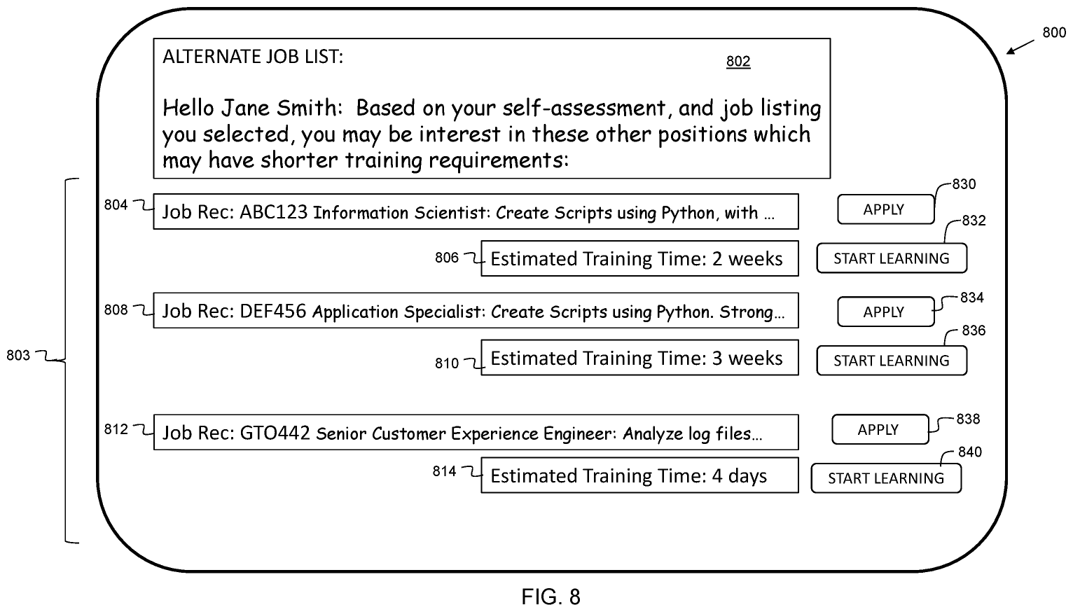

FIG. 8 is a user interface 800 showing an exemplary alternate job list in accordance with disclosed embodiments. User interface 800 includes a summary section 802. The user interface 800 of FIG. 8 can include an alternate job listing section 803. The alternate job listing section can include one or more job descriptions for alternate jobs, as indicated at 804, 808, and 812. While three alternate jobs are shown in user interface 800, in practice, more or fewer job listings may be included in the alternate job listing section 803. Additionally, each job description can include an estimated completion time for completing a customized learning solution for the corresponding job. Field 806 shows an estimated training completion time for the job at 804. Field 810 shows an estimated training completion time for the job at 808. Field 814 shows an estimated training completion time for the job at 812. For each job listing, the user interface 800 includes an Apply button, which when invoked, enables a user to apply for the corresponding job. Apply button 830 corresponds to the job indicated at 804. Start Learning button 832 corresponds to the customized learning solution indicated at 806. Apply button 834 corresponds to the job indicated at 808. Start Learning button 836 corresponds to the customized learning solution indicated at 810. Apply button 838 corresponds to the job indicated at 812. Start Learning button 840 corresponds to the customized learning solution indicated at 814. Additionally, for each job listing, the user interface 800 includes a Start Learning button, which when invoked, enables a user to begin the customized learning solution for the corresponding job. Embodiments can include computing a deficiency list for each job in the alternate job list; and generating a customized learning solution for each job in the alternate job list, based on the corresponding deficiency list.

As can be seen in FIG. 8, disclosed embodiments can provide a convenient way for a user to see available job positions, as well as the amount of training needed to become fully qualified for the job. The estimated time requirements for the training are also provided. The estimated time requirements can be based on the number of minutes of video needing to be viewed and/or number of words needing to be read, in order to complete the customized learning solution. In the example of FIG. 8, the job at 812 is estimated to require four days of training, as indicated at 814. Similarly, the job at 808 is estimated to require three weeks of training, as indicated at 810, and the job at 804 is estimated to require two weeks of training, as indicated at 806. In disclosed embodiments, a user can select a customized learning plan and/or alternate job listing that meets his/her needs. If the user does not have much time for training, he/she can select job 812 with a shorter training time. Conversely, if the user has more time available, he/she may opt for one of the other job listings at 804 or 808, that have longer training requirements, in order to be prepared for the job and/or interviewing/applying for the job.

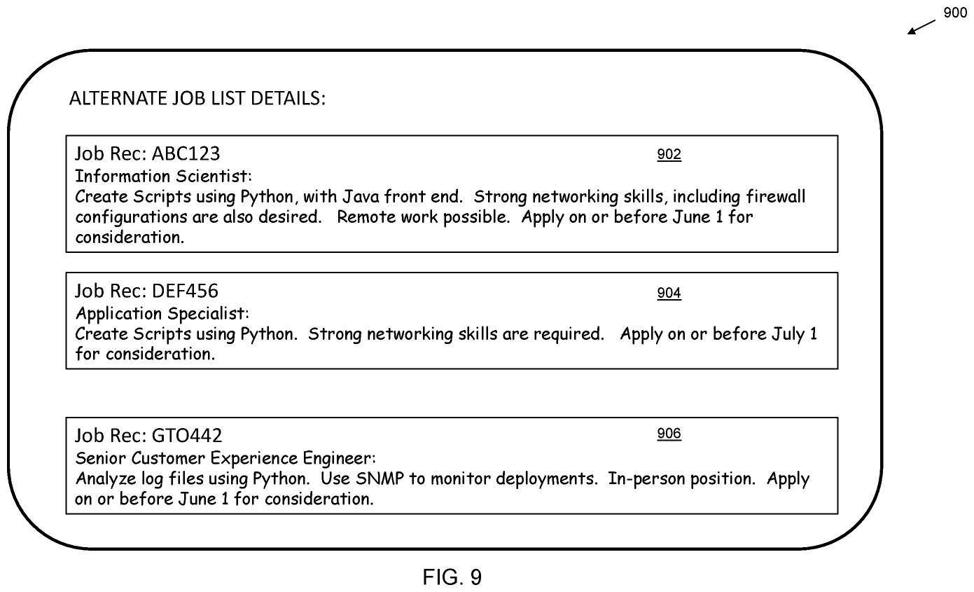

FIG. 9 is a user interface 900 showing exemplary alternate job list details in accordance with disclosed embodiments. Section 902 shows details for a first alternate job. Section 904 shows details for a second alternate job. Section 906 shows details for a third alternate job. While three job listings are shown in user interface 900, in practice, there can be more, or fewer job listings. The user can review the job listings to see the requirements, application deadlines, and/or other information regarding the position.

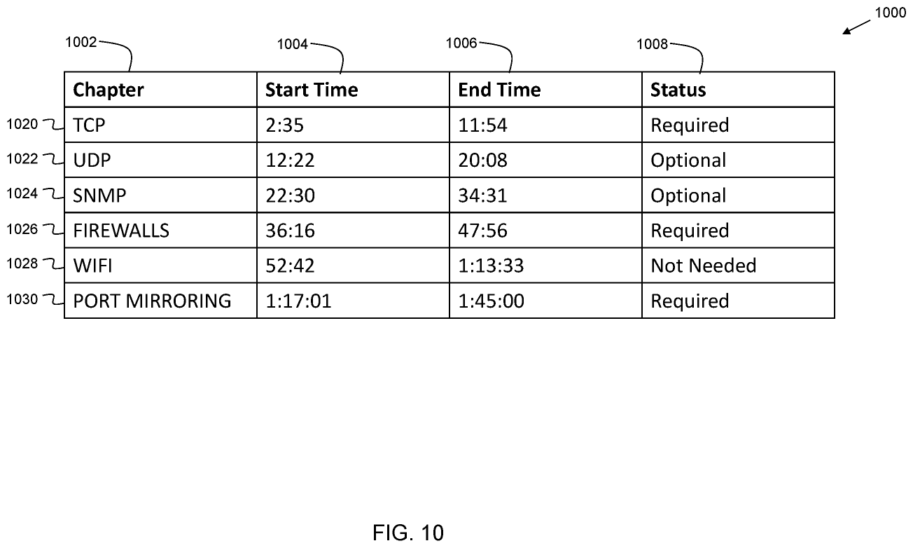

FIG. 10 is an exemplary customized indexing list 1000 in accordance with disclosed embodiments. List 1000 can be created by techniques such as described at block 336 in FIG. 3. List 1000 of FIG. 10 includes four columns. Column 1002 includes a chapter (or section) name. Column 1004 includes a start time for the chapter within a video asset. Column 1006 includes an end time for the chapter within a video asset. Column 1008 includes a status for the chapter. In one or more embodiments, the status for each chapter can have a value including required, not required, and optional. The status value of ‘required’ indicates that a given chapter is a training requirement, based on the job description, possessed skill set, and deficiency list. Similarly, the status value of ‘not required’ indicates that a given chapter is not a training requirement, based on the job description, possessed skill set, and deficiency list. The status value of ‘optional indicates that a given chapter is not a training requirement, but may have some benefit for the job position, based on the job description, possessed skill set, and deficiency list. Embodiments can include obtaining at least one educational video asset; identifying a plurality of sections within the at least one educational video asset; and generating a customized indexing list based on the deficiency list.

List 1000 of FIG. 10 includes six rows. Each row represents a different chapter/section of a video. Row 1020 represents a chapter on TCP, as indicated at column 1002. Row 1022 represents a chapter on UDP, as indicated at column 1002. Row 1024 represents a chapter on SNMP, as indicated at column 1002. Row 1026 represents a chapter on firewalls, as indicated at column 1002. Row 1028 represents a chapter on WiFi, as indicated at column 1002. Row 1030 represents a chapter on port mirroring, as indicated at column 1002. While list 1000 contains six rows corresponding to chapters/sections, other embodiments can include more or fewer rows corresponding to chapters/sections.

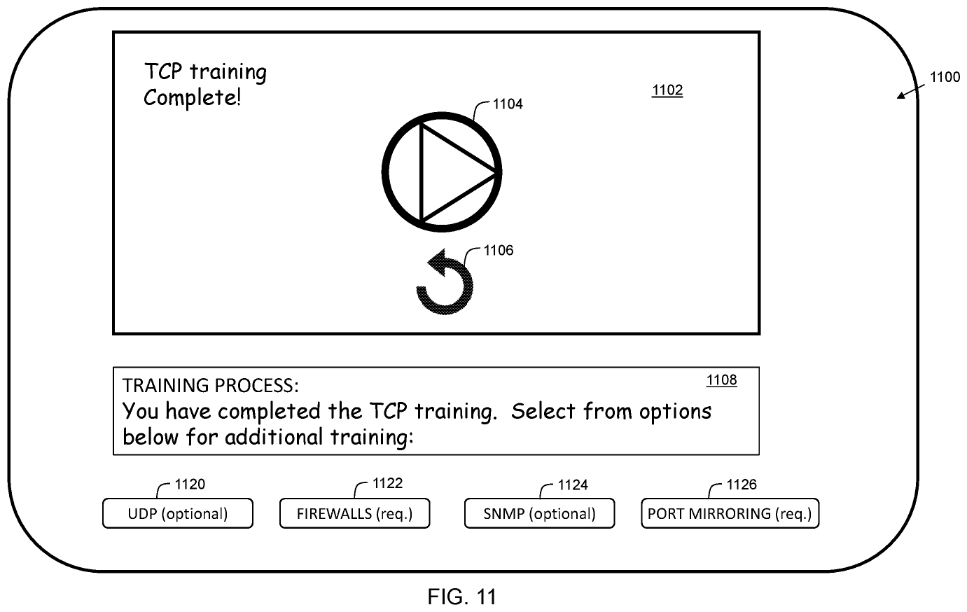

FIG. 11 shows an exemplary training user interface 1100 in accordance with disclosed embodiments. User interface 1100 can include video player window 1102. The video player window can include controls such as play next control 1104 for playing the next video (or section/chapter of a video), and repeat control 1106 for repeating the most recently played video (or section/chapter of a video). In one or more embodiments, invoking a play next control 1104 plays the next required section of a video asset. Considering again the example shown in FIG. 10, if the user just finished viewing the TCP section, corresponding to row 1020, the video playback position is at 11:54, as indicated at row 1020 and column 1006. By invoking the play next control 1104, the playback of the video asset jumps to the next required start time, indicated by the required status at row 1026, column 1008, which in the example, is a chapter starting at time 36:16 as indicated at row 1026, column 1004. By using a player application that can seek to specific times as specified in a customized indexing list such as shown in FIG. 10, disclosed embodiments can provide customized learning solutions without actually having to render new videos that are compilations of various segments of other videos.

Optionally, user interface 1100 may further include a training summary section 1108 that indicates which training sessions have been completed, and/or other information, such as training sessions remaining, and the like. Additionally, user interface 1100 may provide one or more controls, such as buttons, indicated as 1120, 1122, 1124, and 1126, that enable a user to jump to a particular chapter of an educational video asset. In this way, a user is provided the flexibility to repeat lessons, and/or view additional optional lessons, in order to sufficiently prepare for job opportunities to advance his/her career.

As can now be appreciated, disclosed embodiments provide a customized learning solution that generates a unique, personalized, and cost-effective curriculum program that suits the needs of a user, and bolsters the skills he/she needs to take their career to the next level. Embodiments can present a wide variety of educational and/or training paths, including, but not limited to, a least costly path, an earliest date path (complete the training as soon as possible), a shortest time path (complete the training with the minimum time spent participating in training), university/college courses, certificates, and so on. Embodiments can further incorporate ratings for courses in creating the customized learning solution. Higher rated courses and/or training programs can be prioritized for inclusion in a customized learning solution. The ratings can include published ratings, crowdsourced ratings, and/or other sources of ratings. Disclosed embodiments can store the generated curriculum data in a repository for future use by other individuals with similar learning needs, thereby increasing the effectiveness of the customized curriculum generation system.

Disclosed embodiments provide users with a personalized skill development plan to enable new career opportunities. As new curriculum components are generated and become available, they can be shared with other users participating in the system. Disclosed embodiments utilize kNN (nearest neighbors), K-means, random forest, clustering, and/or other suitable techniques for identifying other users with similar learning needs. Disclosed embodiments can further perform processes including classifying new learning opportunities that are generated based on a user's assessment. A priority value can be assigned to each skill based on the value that the skill may offer to the other users. Furthermore, a value can be assessed and assigned for each new skill or learning opportunity by comparing the skill value with the specific job interest or available position for each user in the repository. User profiles can then be updated, and users can be proactively notified regarding recommendations for learning tasks and new recommended learning plans. Thus, disclosed embodiments enable the quick creation of efficient and highly personalized training materials for workers with different skill levels and/or different career aspirations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for curriculum generation, comprising:
obtaining a first job description;
obtaining a possessed knowledge set for a user;
determining a deficiency list based on the first job description and the possessed knowledge set; and
generating a customized learning solution based on the deficiency list, wherein the customized learning solution comprises at least one subset of material from a curriculum material corpus.

2. The method of claim 1, further comprising:
obtaining a time range; and
wherein generating the customized learning solution is based on the time range.

3. The method of claim 1, further comprising:
obtaining a cost range; and
wherein generating the customized learning solution is based on the cost range.

4. The method of claim 1, further comprising:
obtaining an instruction type preference; and
wherein generating the customized learning solution is based on the instruction type preference.

5. The method of claim 1, further comprising, creating an alternate job list, wherein the alternate job list is based on the first job description and the possessed knowledge set.

6. The method of claim 5, further comprising:
computing a deficiency list for each job in the alternate job list; and
generating a customized learning solution for each job in the alternate job list, based on the corresponding deficiency list.

7. The method of claim 1, further comprising:
generating a self-assessment test, based on the first job description; and
wherein obtaining the possessed knowledge set comprises computing a score for the self-assessment test based on received input for the self-assessment test.

8. The method of claim 1, wherein generating the customized learning solution comprises:
obtaining at least one educational video asset;
identifying a plurality of sections within the at least one educational video asset; and
compiling a subset of the plurality of sections into a new educational video asset, based on the deficiency list.

9. The method of claim 8, further comprising, storing the new educational video asset in a knowledge base repository.

10. The method of claim 1, wherein generating the customized learning solution comprises:
obtaining at least one educational video asset;
identifying a plurality of sections within the at least one educational video asset; and
generating a customized indexing list based on the deficiency list.

11. An electronic computation device comprising:
a processor;
a memory coupled to the processor, the memory containing instructions, that when executed by the processor, cause the electronic computation device to:
obtain a first job description;
obtain a possessed knowledge set for a user;
determine a deficiency list based on the first job description and the possessed knowledge set; and
generate a customized learning solution based on the deficiency list, wherein the customized learning solution comprises at least one subset of material from a curriculum material corpus.

12. The electronic computation device of claim 11, wherein the memory further comprises instructions, that when executed by the processor, cause the electronic computation device to obtain a time range, and generate the customized learning solution based on the time range.

13. The electronic computation device of claim 11, wherein the memory further comprises instructions, that when executed by the processor, cause the electronic computation device to obtain a cost range, and generate the customized learning solution based on the cost range.

14. The electronic computation device of claim 11, wherein the memory further comprises instructions, that when executed by the processor, cause the electronic computation device to obtain an instruction type preference, and generate the customized learning solution based on the instruction type preference.

15. The electronic computation device of claim 11, wherein the memory further comprises instructions, that when executed by the processor, cause the electronic computation device to:
obtain at least one educational video asset;
identify a plurality of sections within the at least one educational video asset; and
compile a subset of the plurality of sections into a new educational video asset, based on the deficiency list.

16. The electronic computation device of claim 15, wherein the memory further comprises instructions, that when executed by the processor, cause the electronic computation device to store the new educational video asset in a knowledge base repository.

17. The electronic computation device of claim 11, wherein the memory further comprises instructions, that when executed by the processor, cause the electronic computation device to:
obtain at least one educational video asset;
identify a plurality of sections within the at least one educational video asset; and
generate a customized indexing list based on the deficiency list.

18. A computer program product for an electronic computation device comprising a computer readable storage medium having program instructions embodied therewith, the program instructions executable by a processor to cause the electronic computation device to:
obtain a first job description;
obtain a possessed knowledge set for a user;
determine a deficiency list based on the first job description and the possessed knowledge set; and
generate a customized learning solution based on the deficiency list, wherein the customized learning solution comprises at least one subset of material from a curriculum material corpus.

19. The computer program product of claim 18, wherein the computer readable storage medium further comprises program instructions, that when executed by the processor, cause the electronic computation device to:
obtain at least one educational video asset;
identify a plurality of sections within the at least one educational video asset; and
compile a subset of the plurality of sections into a new educational video asset, based on the deficiency list.

20. The computer program product of claim 18, wherein the computer readable storage medium further comprises program instructions, that when executed by the processor, cause the electronic computation device to:
obtain at least one educational video asset;
identify a plurality of sections within the at least one educational video asset; and
generate a customized indexing list based on the deficiency list.
